(19) United States
(12) Patent Application Publication
(10) Pub. No.: US 2012/0147458 A1
(43) Pub. Date: Jun. 14, 2012

(54) MEMBER FOR A STRUCTURE INCLUDING A SOLAR CONTROL LAYER

(75) Inventors: Olivier E. Selles, Aachen (DE); Marc Maurer, Saint-Jean aux Bois (FR)

(73) Assignee: CertainTeed Corporation, Valley Forge, PA (US)

(21) Appl. No.: 12/964,482

(22) Filed: Dec. 9, 2010

(51) Int. Cl. G02B 5/26

(52) U.S. Cl. 359/359

(57) ABSTRACT

A member for a structure can include a substrate having a visible outer surface. The member can also include a solar control layer disposed between the substrate and an outdoor environment. In an embodiment, as seen along an outer surface of the member, the solar control layer does not significantly alter the appearance of the member as compared to the member in an absence of the solar control layer. Such appearance can include a particular color, wood grain, masonry surface, another suitable appearance characteristic, or any combination thereof. In another embodiment, a member for a structure can include a substrate, an intermediate layer, and a solar control layer, wherein the intermediate layer comprises a primary material that is susceptible to significant degradation when exposed during a plasma deposition.

### FIELD OF THE DISCLOSURE

The present disclosure relates to processes of forming members for structures, and more particularly to, processes of forming members for structures, wherein the members include solar control layers.

### RELATED ART

Buildings are susceptible to heating due to radiation emitted from the sun. Some building materials may reflect little near-infrared (“NIR”) radiation and consequently absorb substantial solar heat. This absorption of solar heat typically results in elevated temperatures in the environment surrounding the exposed building material.

In an attempt to address heating caused by NIR radiation, incorporation or application of white- or light-colored pigments or coatings onto building materials have been used. However, such a limited selection of colors may not be desired. In another attempt to address heating caused by NIR radiation, metal sheets or metal flakes, such as aluminum flakes, may be used. However, metal sheets or metal flakes may not be desired by some consumers. Other colored pigments may be relatively high in cost, provide a limited solar reflectance, and are not available in all colors.

The building codes of some cities require low-emissivity glass to be used for all new construction and replacement transparent glass windows. A low-emissivity transparent glass window includes a coating, often based on a thin layer of metal, applied to one or more surfaces of the transparent glass, where the coating reflects at least some of the NIR radiation.

### BRIEF DESCRIPTION OF THE DRAWINGS

Embodiments are illustrated by way of example and are not limited in the accompanying figures.

FIG. 1 includes an illustration of a side view of a structure that includes different building materials.

FIG. 2 includes an illustration of a cross-sectional view of a structure including a member, an intermediate layer, and a solar control layer.

FIG. 3 includes an illustration of a cross-sectional view of a structure including a member and a solar control layer.

FIG. 4 includes an illustration of a cross-sectional view of a structure including a member, an intermediate layer, a solar control layer, and an outer layer.

FIG. 5 includes an illustration of a cross-sectional view of a substrate.

FIG. 6 includes an illustration of a cross-sectional view of the substrate of FIG. 5 after depositing a solar control layer over the substrate.

FIG. 7 includes an illustration of a cross-sectional view of another substrate.

FIG. 8 includes an illustration of a cross-sectional view of an intermediate layer.

FIG. 9 includes an illustration of a cross-sectional view of the substrate of FIG. 7, and intermediate layer of FIG. 8, and the substrate and solar control layer of FIG. 6 before the items are coupled together.

FIG. 10 includes an illustration of a cross-sectional view of the items of FIG. 9 after the items are coupled together.

FIG. 11 includes an illustration of a cross-sectional view of the items of FIG. 10 during removal the substrate of FIG. 5.

FIG. 12 includes an illustration of a cross-sectional view of the items of FIG. 10 after removing the substrate of FIG. 5.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

Before addressing details of the embodiments described below, some terms are defined or clarified. The term “elemental metal” is intended to mean a metal that consists essentially of a single atomic element, regardless of crystallinity or a lack thereof. Compare Ti, TiW, and TiN. Ti (not part of an alloy or compound) is an elemental metal. TiW is an alloy having dissimilar atomic elements, TiN is a compound having dissimilar atomic elements, and therefore, TiW and TiN are not elemental metals.

The term “film” is intended to mean a discrete constituent of a layer, as recited below.

The term “layer” is intended to mean a functional unit including a single film or a plurality of films. For example, an insulating layer may have a function of providing electrical insulation between two locations along opposite sides of the insulating layer. The insulating layer can include a single film of an oxide, a nitride, or an oxynitride, or the insulating layer can include a combination of any two or more of oxide, nitride, or oxynitride films. For the latter example, an oxide film, a nitride film, or an oxynitride film would be a discrete film within the plurality of films that make up the insulating layer.

The term “near infrared radiation” (also, “NIR radiation”) is intended to mean a radiation spectrum having wavelengths corresponding to 700 nm to about 2500 nm.

The term “polymer” is intended to refer to a homopolymer, a copolymer, or any combination thereof.

The term “visible light” is intended to mean a radiation spectrum having wavelengths corresponding to 400 nm to 700 nm.

As used herein, the terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts.

A member for a structure includes a substrate and a solar control layer. The member can be configured so that visible light can be transmitted to and from an underlying substrate while reflecting a significant amount of NIR radiation and without significantly altering the appearance of the underlying substrate when the solar control layer is present. The underlying substrate can include a variety of building materials that can be used for a structure. A novel processing technique allows a much greater variety of materials to be used for a solar control layer that would otherwise be difficult or substantially impossible to deposit directly on structural materials commonly used. The figures and description below provide some exemplary applications and processes to form members for a structure. After reading this specification, skilled artisans will appreciate that other applications and processes can be used without departing from the concepts described herein.

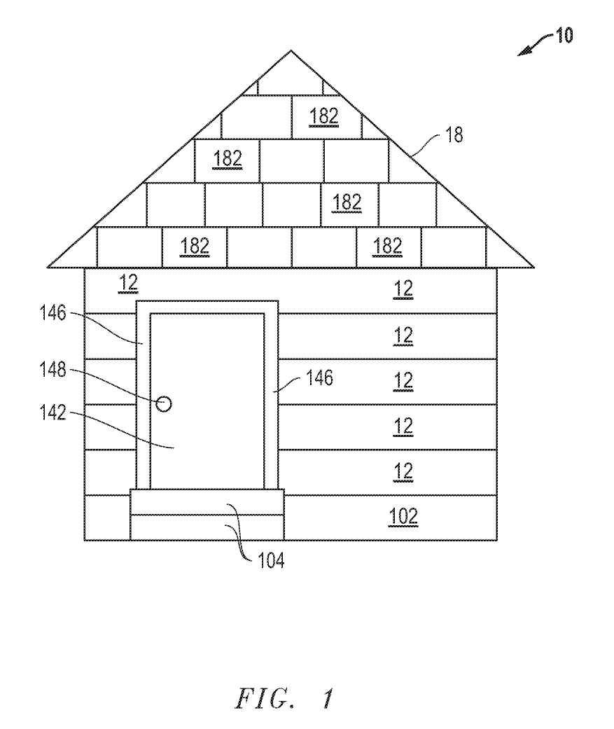

FIG. 1 includes an illustration of a side view of a structure 10 that includes different building materials. In the illustrated embodiment, the structure 10 includes a house or another habitat. Another structure can include another building, such as an office building, an outdoor structure for a pet, an outdoor structure that is susceptible to being heated by sunlight, such as metal bleachers, or the like. The structure 10 includes a foundation 102 and stairs 104. The structure 10 has walls that include siding 12. In another embodiment (not illustrated), masonry or another material may present along the along an exposed surface along the walls of the structure 10. The structure 10 further includes a door having a main body 142 and a door knob 148. Door frame 146 lies adjacent to sides of the door. The structure 10 includes a roof 18 that is covered by roofing articles, such as roofing shingles 182. In another embodiment, the roofing articles can include a membrane, a tile (natural or man-made), metal roofing, another suitable roofing article, or any combination thereof.

Any of the foregoing members of the structure 10 can include a substrate and a solar control layer. The member may be part of or form part of an exterior surface of the structure 10. The substrate of the member can include a pair of opposing surfaces that include an interior-facing surface and an outer visible surface. The substrates for the members of the structure 10 may be substantially opaque to visible light. The substrate can have an appearance that is the desired appearance for that particular part of the structure 10. For example, the substrate of the siding 12 has an outer visible surface that may have a particular color, wood grain, masonry surface, or other appearance that the owner desires to be seen.

The solar control layer can reflect a significant amount of NIR radiation away from the structure 10, and therefore, can help to reduce the amount of solar heating of the structure 10. Similarly, the same or a different solar control layer may be used for roofing articles, the door, door or window frames, and other exposed portions of the structure 10. The solar control layer can be capable of transmitting at least 5% of radiation having a wavelength within the visible light spectrum. In another embodiment, the solar control layer is capable of transmitting at least 50% of radiation having a wavelength within the visible light spectrum, and in a particular embodiment, the solar control layer is capable of transmitting at least 70% of radiation having a wavelength within the visible light spectrum. The solar control layer can be capable of reflecting at least 1% of radiation having a wavelength within the NIR spectrum. In another embodiment, the solar control layer is capable of reflecting at least 30% of radiation having a wavelength within the NIR spectrum, and in a particular embodiment, the solar control layer is capable of reflecting at least 60% of radiation having a wavelength within the NIR spectrum.

The solar control layer can allow visible light to be transmitted to the outer visible surface of the substrate, and other visible light reflected by the outer visible surface to be transmitted away from the structure 10. For example, in the absence of the solar control layer, the outer visible surface of the substrate may reflect a color that would be seen by an observer. When the solar control layer is present, the combination of the substrate and solar control layer may reflect a color that is similar or substantially the same as the color reflected by the outer visible surface of the substrate. In this specification, color is specified in terms of 1976 CIE (Commission Internationale de L′Eclairage) color space coordinates of L*, a*, and b*, wherein L* represents lightness of the color (L*=0 is black, and L*=100 indicates diffuse white; specular white may be higher), a* represents a position between red/magenta and green (a*, negative values indicate green while positive values indicate magenta), and b* represents a position between yellow and blue (b*, negative values indicate blue and positive values indicate yellow). In an embodiment, a set of L*, a*, b* coordinates for the outer visible surface of the substrate with and without the solar control layer are within approximately 5 units of each other, and in another embodiment, the set of L*, a*, b* coordinates are within approximately 10 units of each other. In a particular embodiment, the set of L*, a*, b* coordinates are within approximately 4 units of each other.

More details regarding the properties and compositions of the members for the structure 10 are described in more detail with processing details later in this specification.

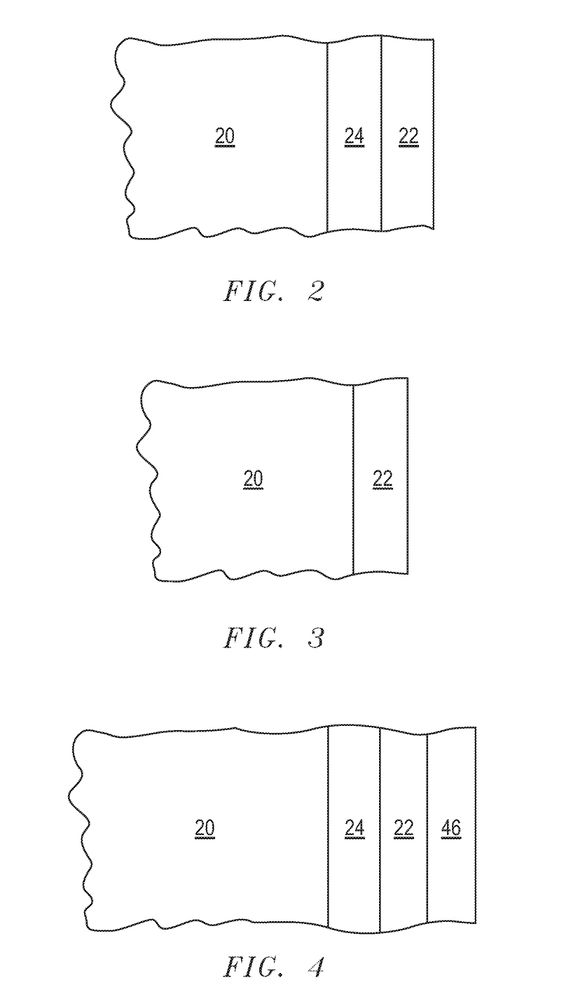

FIGS. 2 to 4 include some exemplary configurations of a member including a substrate and a solar control layer. FIG. 2 includes an illustration of a cross-sectional view of a substrate 20, a solar control layer 22, and an intermediate layer 24 that is disposed between the substrate 20 and the solar control layer 22. The intermediate layer 24 can be a tie layer, and may help with adhesion, reduce surface roughness (for example, at the substrate surface), or reduce stress that can occur as the outdoor temperature changes. FIG. 3 is similar to FIG. 2 except that the intermediate layer 24 is not present. The solar control layer 22 may have sufficient adhesion to the substrate 20 that the intermediate layer may not be needed. FIG. 4 is similar to FIG. 2 except that an outer layer 46 lies along an outer surface of the solar control layer 22. The outer layer 46 may help to protect the solar control layer 22, enhance the visual appearance of the member, provide another suitable purpose, or any combination thereof.

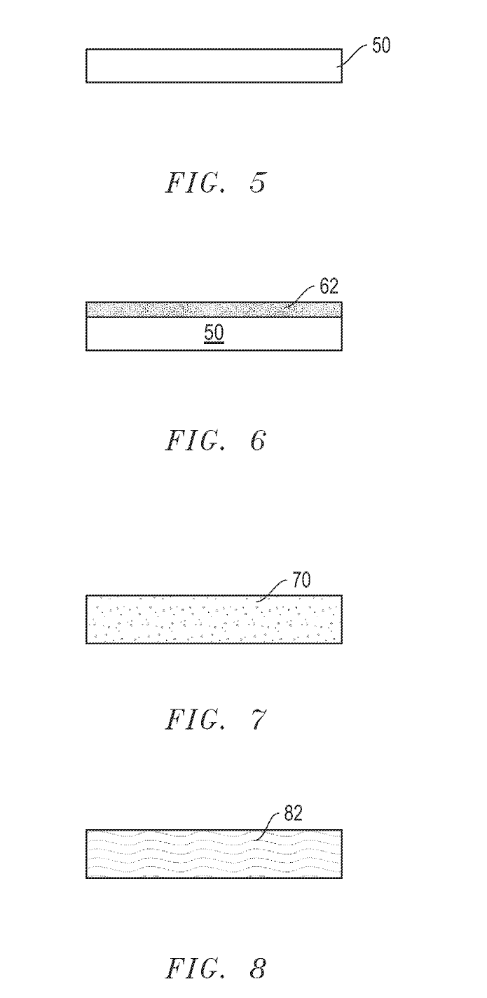

FIGS. 5 to 12 include illustrations for exemplary processing techniques that can be used to form members for structures, such as structure 10. The process sequence forms a member having a configuration as illustrated in FIG. 2. After reading this specification, skilled artisans will appreciate that the other configurations illustrated in FIGS. 3 and 4 and further configurations can be made without departing from the concepts described herein.

The solar control layer can be deposited using a plasma-assisted technique of a physical vapor deposition (“PVD”) or chemical vapor deposition (“CVD”). Many structural members may not be well suited for such plasma-assisted techniques due to material compatibility or size or handling constraints. Some materials, such as wood, stains, or other coatings may degrade or have other issues when subjected to a plasma. Some substrates may be compatible with a plasma-assisted technique; however, the substrate may be relatively large (for example, metal benches for bleachers, a playground slide, etc.) or may be fragile or brittle. The techniques as described herein allow composition and thickness control seen with plasma-assisted PVD and CVD techniques without requiring the substrate to be exposed to a plasma within a limited space within a PVD or CVD chamber.

FIG. 5 includes an illustration of a cross-sectional view of a portion of a substrate 50 over which the solar control layer will be deposited. Thus, the substrate 50 will be subsequently exposed to a plasma-assisted PVD or CVD process. Further, the solar control layer will subsequently adhere more strongly to another surface later in the process, and therefore, the solar control layer should not adhere too strongly to the substrate 50.

The exposed surface of the substrate 50 can include a halogenated compound, such as a fluorinated compound, a chlorinated compound, or a combination thereof. In an embodiment, the fluorinated compound can include a fluorinated polymer or a fluorinated silicone rubber. The fluoropolymer can be a homopolymer of fluorine-substituted monomers or a copolymer including at least one fluorine-substituted monomer. Exemplary fluorine substituted monomers include vinyl fluoride, tetrafluoroethylene (TFE), vinylidene fluoride (VF2), hexafluoropropylene (HFP), chlorotrifluoroethylene (CTFE), perfluoroethylvinyl ether (PEVE), perfluoromethylvinyl ether (PMVE), and perfluoropropylvinyl ether (PPVE). Examples of fluorinated polymers include polytetrafluoroethylene (PTFE), perfluoroalkylvinyl ether (PFA), fluorinated ethylene-propylene copolymer (FEP), ethylene tetrafluoroethylene copolymer (ETFE), polyvinylidene fluoride (PVDF), polychlorotrifluoroethylene (PCTFE), TFE copolymers with VF2 or HFP, ethylene chlorotrifluoroethylene copolymer (ECTFE), a copolymer of ethylene and fluorinated ethylene propylene (EFEP), a terpolymer of tetrafluoroethylene, hexafluoropropylene, and vinylidene fluoride (THVF), a terpolymer of tetrafluoroethylene, hexafluoropropylene, and ethylene (HTE), or any combination thereof. In particular, the fluoropolymer is melt processable. For example, the fluoropolymer can be polyvinylidene fluoride (PVDF), ethylene tetrafluoroethylene copolymer (ETFE), polychlorotrifluoroethylene (PCTFE), ethylene chlorotrifluoroethylene copolymer (ECTFE), fluorinated ethylene propylene copolymer (FEP), a copolymer of ethylene and fluorinated ethylene propylene (EFEP), a terpolymer of tetrafluoroethylene, hexafluoropropylene, and vinylidene fluoride (THV), a terpolymer of tetrafluoroethylene, hexafluoropropylene, and ethylene (HTE), or any combination thereof. For example, the fluoropolymer can be a fluorinated ethylene propylene copolymer (FEP). In another example, the fluoropolymer can be a copolymer of ethylene and tetrafluoroethylene (ETFE).

In an embodiment, the chlorinated compound can include a chlorinated polymer. In addition to the chloropolymers previously described with respect to the fluoropolymers, the chloropolymer can be a homopolymer of chlorine-substituted monomers or a copolymer including at least one chlorine-substituted monomer. Exemplary chlorine substituted monomers include vinyl chloride, tetrachloroethylene (TCE), vinylidene chloride (VC2), hexachloropropylene (HCP), chlorotrichloroethylene (CTCE), perchloroethylvinyl ether (PEVE), perchloromethylvinyl ether (PMVE), and perchloropropylvinyl ether (PPVE). Examples of chlorinated polymers include polytetrachloroethylene (PTCE), perchloroalkylvinyl ether (PCA), chlorinated ethylene-propylene copolymer (CEP), ethylene tetrachloroethylene copolymer (ETCE), polyvinylidene chloride (PVDC), TCE copolymers with VC2 or HCP, a copolymer of ethylene and chlorinated ethylene propylene (ECEP), a terpolymer of tetrachloroethylene, hexachloropropylene, and vinylidene chloride (THVC), a terpolymer of tetrachloroethylene, hexachloropropylene, and ethylene (HTE), or any combination thereof. In particular, the chloropolymer is melt processable. For example, the chloropolymer can be polyvinylidene chloride (PVDC), ethylene tetrachloroethylene copolymer (ETCE), chlorinated ethylene propylene copolymer (CEP), a copolymer of ethylene and chlorinated ethylene propylene (ECEP), a terpolymer of tetrachloroethylene, hexachloropropylene, and vinylidene chloride (THV), a terpolymer of tetrachloroethylene, hexachloropropylene, and ethylene (HTE), or any combination thereof. For example, the chloropolymer can be a chlorinated ethylene propylene copolymer (CEP). In another example, the chloropolymer can be a copolymer of ethylene and tetrachloroethylene (ETCE).

In another embodiment, the exposed surface of the surface 50 may not include a halogenated compound. In a particular embodiment, the exposed surface can include a polycarbonate, a polyolefin (polypropylene, polyethylene, or the like), a polyacrylate, a polyester, a cellulose acetate film, another suitable polymer, or any combination thereof.

The exposed surface of the surface 50 can also include a polymer coated with a siloxane varnish or with an acrylate varnish formulated in a way that the solar control layer does not adhere too strongly on the coated polymer. In one embodiment, the substrate 50 can consist essentially of any of the foregoing materials, and in another embodiment, the substrate 50 can include a base layer that is covered by a release coating or other layer of any of the foregoing materials. In a particular embodiment, the release coating can include silicone or a cross-linked polymer, such as a melamine-formaldehyde resin. The base layer, the release coating or other layer may be translucent or substantially opaque to visible light.

FIG. 6 includes an illustration of a cross-sectional view of the substrate 50 after depositing a solar control layer 62 over the substrate 50. The solar control layer 62 can have any one or more of the transmissive or reflective properties as previously described. The solar control layer 62 can include a single film or a plurality of films. Each film can be an electrically conductive film or a dielectric film. In a particular embodiment, the solar control layer can include a combination of electrically conductive and dielectric films, such as an electrically conductive film disposed between a pair of dielectric films. Each film, whether an electrically conductive film or a dielectric film, can include a metal-containing material, for example an elemental metal, a metal oxide, a metal nitride, a metal oxynitride, another suitable metal-containing material, or any combination thereof. The solar control layer 62 may have an exposed surface that has a glossy or matte finish. In an embodiment, the solar control layer 62 may be translucent or otherwise capable of scattering visible light.

The thickness of the solar control layer 62 has no known upper theoretical limit; however, as the thickness of the solar control layer 62 increases, the transmission of visible light decreases. The solar control layer 62 may be substantially transparent to all wavelengths within the visible light spectrum or may reflect a color that is close to the color of the visible outer surface of the substrate of the member for the structure. In an embodiment, the solar control layer 62 has a thickness no greater than 5 μm, and in another embodiment, the solar control layer 62 has a thickness no greater than 500 μm. Similar to the solar control layer 62, each film within the solar control layer has no known theoretical upper limit. In an embodiment, each film has a thickness no greater than 200 μm, and in another embodiment, each film has a thickness no greater than 90 μm. Each film within the solar control layer 62 can have a transmission of visible light or a reflection of a color that varies with the thickness of the film.

When the solar control layer includes a plurality of films, modeling or empirical testing can be performed to achieve a desired transmission of visible light, a reflection of a color, or a combination thereof. For example, if the visible outer surface of the substrate of the member for the structure has a particular light blue color, the solar control layer 62 may be configured to be substantially transmissive over substantially all of the visible light spectrum or, within the visible light spectrum, only reflect a color close to the particular light blue color, such that the visible appearance is substantially the same regardless of whether the solar control layer 62 would be used with the substrate of the member for the structure. After reading this specification, skilled artisans will be able to determine the particular composition and thickness of the solar control layer 62, including the number of films and the corresponding composition and thickness for a particular application.

Deposition of the solar control layer can be performed using a plasma-assisted technique, such as a plasma-assisted PVD or CVD process. The PVD process can be performed by sputtering the layer. The sputtering can be performed as radio-frequency (“RF”) sputtering, magnetron sputtering, bias sputtering, or the like using a corresponding sputtering apparatus. The sputtering target can have substantially the same composition as the film being deposited. In another embodiment, a reactive sputtering technique may be used. Sputtering can be performed while a chuck or other substrate holder is at approximately room temperature (for example approximately 20° C. to approximately 25° C. In another embodiment, the chuck or other substrate holder may be maintained at a temperature above room temperature. For a CVD process, an organometallic precursor, a metal halide, or a metal hydride may be used. The temperature to deposit the film may be reduced when using a plasma, and therefore, the deposition temperature can be lower than approximately 250° C., and may be lower than approximately 200° C. or even lower than approximately 150° C. By selecting the materials as described with respect to the substrate 50, the solar control layer 62 can be deposited without substantially destroying the substrate 50. The substrate 50 may only be used one time or may be used for a plurality of times in depositing solar control layers before the substrate 50 is no longer used.

FIG. 7 includes an illustration of cross-sectional view of a portion of a substrate 70 of a member for a structure. The substrate 70 can be any of the different parts of the structure 10, for example the siding 12, the roofing articles, such as roofing shingles 182, the door 142, the door frame 146, and the like. For simplicity, the process will be described with respect to the siding 12 as being the substrate. The siding 12 can be made of a natural or man-made material, such as wood, metal, polymer, or a composite material. The visible outer surface of the siding 12 may include a painted or stained surface that provides a desired visual appearance. In another embodiment, the substrate 70 can include a polyester, a polyurethane, a polyvinyl butyral, a silicone, a polyimide, a polyamide, a polyolefin, a polyvinyl chloride, a polycarbonate, a polyacrylate, or any combination thereof. A polyacrylate can include an acrylic homopolymer or an acrylic copolymer, such as an acrylonitrile-styrene-acrylate copolymer, an acrylonitrile-ethylene-styrene copolymer.

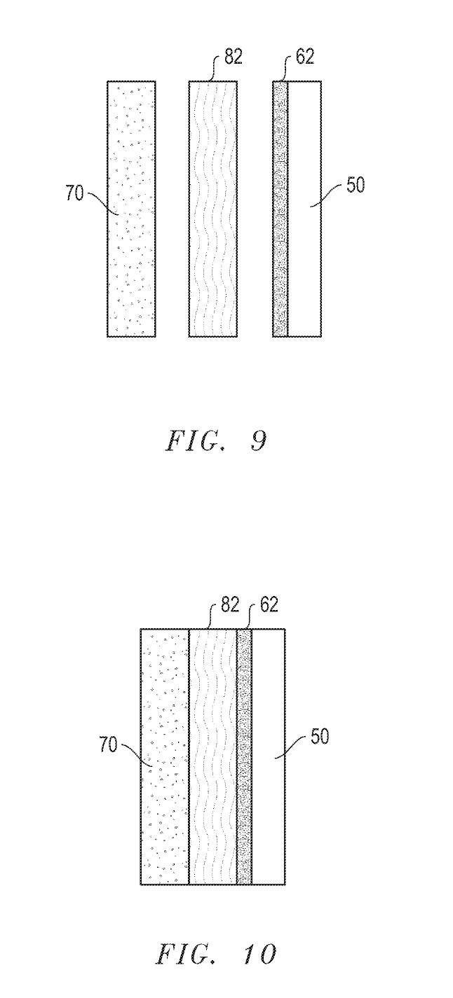

FIG. 8 includes an illustration of cross-sectional view of a portion of an intermediate layer 82 that can be used between the substrate 70 and the solar control layer 62. The use of the intermediate layer 82 may be optional and may be a stand-alone layer or may be formed or applied over the substrate 70 or the solar control layer 62. The intermediate layer 82 can be used for a tie layer, as a barrier layer, serve another suitable function, or any combination thereof. The intermediate layer 82 may be substantially transparent to substantially all wavelengths within the visible light spectrum. In a particular embodiment, the solar control layer 62 adheres more strongly to the intermediate layer 82 that to the substrate 50. In an embodiment, the intermediate layer 82 has a thickness no greater than 10 mm, and in another embodiment, the intermediate layer 82 has a thickness no greater than 2 mm. In a particular embodiment, the intermediate layer 82 has a thickness in a range of approximately 0.01 mm to approximately 1 mm.

Similar to the substrate 70, the intermediate layer 82 may not be well suited for exposure during a plasma-assisted process, such as the one previously described with respect to the deposition of solar control layer 62. For example, the substrate 70, the intermediate layer 82, or both may be susceptible to significant degradation if exposed during a plasma deposition. The intermediate layer 82 can include a polyester, a polyurethane, a polyvinyl butyral, a silicone, a polyimide, a polyamide, or any combination thereof. In a particular embodiment, the substrate 70 may have a rough or irregular surface (for example, a roofing shingle, a masonry facade, or the like). The intermediate layer 82 can include a pressure-sensitive adhesive compound, such as any described within U.S. Pat. No. 5,310,278, which is incorporated herein for its teachings of pressure-sensitive adhesive compounds.

FIG. 9 includes an illustration of a cross-sectional view of an embodiment illustrating the arrangement of the substrates and the layers before they are coupled together. In the embodiment illustrated in FIG. 9, the intermediate layer 82 is disposed between the substrate 70 and the solar control layer 62, and the solar control layer is disposed between the substrate 70 and the substrate 50.

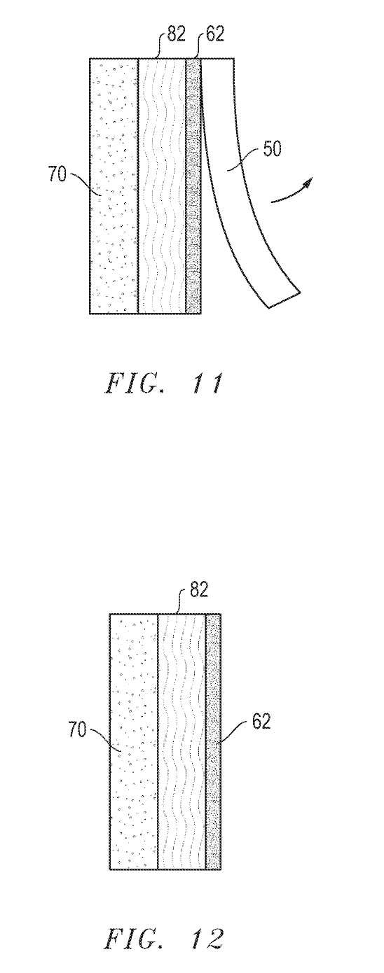

FIG. 10 includes an illustration of a cross-sectional view of an embodiment after the substrates and the layers are coupled together. The coupling can be preformed before or after the member is installed on or as part of the structure. The conditions for coupling the layers together may depend on the layers present and the composition of those layers, if the conditions are not to affect adversely the substrates or the layers. Coupling can include laminating the substrates and layers to one another. In an embodiment, the lamination can performed at a temperature of at least approximately 0° C., and in another embodiment, at a temperature of at least approximately 50° C. In a further embodiment, the lamination may be performed at a temperature no greater than approximately 250° C., and in another embodiment, no greater than approximately 200° C. In a particular embodiment, the temperature is in a range of approximately 100° C. to approximately 150° C. The pressure for lamination can be at a pressure just above 0 Pa, and in another embodiment, at a pressure of at least 200 kPa. In a further embodiment, the lamination may be performed at a pressure no greater than approximately 5000 kPa, and in another embodiment, no greater than approximately 15000 kPa. In a particular embodiment, the pressure is in a range of approximately 900 kPa to approximately 1200 kPa.

FIG. 11 includes an illustration of a cross-sectional view of an embodiment while the substrate 50 is being removed. As illustrated, the substrate 50 can be peeled away from the solar control layer 62. Because the solar control layer 62 adheres more strongly to the intermediate layer 82 as compared to the substrate 50, most of the solar control layer 62 remains laminated to the intermediate layer 82, as compared to the substrate 50. In a particular embodiment, substantially all of the solar control layer 62 remains laminated to the intermediate layer 82 after the substrate 50 is removed. In another embodiment, a residual amount of the solar control layer 62 remains laminated to the substrate 50; however, most of the solar control layer 62 remains attached to the intermediate layer 82. In another embodiment, another removal technique may be used to remove the substrate 50. For example, a solvent or a wet chemical etchant may selectively attack the substrate 50 in preference to the solar control layer 62. After reading this specification, skilled artisans will appreciate that the particular removal technique selected may depend on the particular materials or subsequent use of the member.

FIG. 12 includes an illustration of a cross-sectional view of a substantially completed member for a structure. The member includes the substrate 70, the intermediate layer 82, and the solar control layer 62. As seen from an outer surface of the solar control layer, a combination of the solar control layer 62 and the intermediate layer 82 does not significantly alter the appearance of the member as compared to the member in the absence of the combination of the solar control layer 62 and the intermediate layer 82. The member can reflect a significant amount of NIR radiation, and therefore, can reduce the amount of heat transferred into a structure via the member. Although the process has been described principally with respect to the siding 12, other members of a structure (door 142, roofing articles, fencing, decking, railing, door frame 146, window frame, etc.) can also include the solar control layer 62 and significantly reduce the amount of heating caused by sunlight.

In another embodiment, the solar control layer 62 may sufficiently adhere to and not have a significant material incompatibility issue with the substrate 70. In such an embodiment, the intermediate layer 82 may not be present, and the solar control layer 62 may directly contact the substrate 70. In a further embodiment, a protective layer (not illustrated) may be needed or desired. The protective layer may protect the solar control layer 62 during shipping or handling or improve long-term reliability of the solar control layer 62. In a particular embodiment, the protective layer may be removed shortly before or shortly after the member is installed. In another particular embodiment, the protective layer may remain over the solar control layer 62 or may be installed over the solar control layer 62 after the member is installed.

In still another embodiment, the intermediate layer 82 may still be disposed adjacent to the substrate 50; however, it may be disposed between the substrate 50 and the solar control layer 62, rather than the solar control layer 62 being disposed between the substrate 50 and the intermediate layer 82. When the intermediate layer 82 is disposed between the substrate 50 and solar control layer 62, the intermediate layer 82 can help to protect the solar control layer 62 after the substrate 50 is removed. More particularly, when the substrate 50 is removed, the intermediate layer 82 remains in contact with the solar control layer 62 when the solar control layer 62 is transferred to the substrate 70. The intermediately layer 82 remain permanently (that is, not intended to be removed) to protect the solar control layer 62. Alternatively, the intermediate layer 82 may temporarily protect the solar control layer 62, such as during shipment of the combination of the substrate 70 and solar control layer 62. Just before, during, or just after the substrate 70 is installed, the intermediate layer 82 may be removed from the solar control layer 62. In a further embodiment, different intermediate layers may be used between the substrate 50 and the solar control layer 62 and between the solar control layer 62 and the substrate 70.

After reading this specification, skilled artisans will appreciate that many different arrangements of layers are possible. After determining which layers directly contact which other layers, and whether each layer is to remain permanently in place or removed, particular materials can be selected for each of the layers to ensure that the relative adhesive properties between the layers that are in direct contact with each other are consistent with the design. For example, the substrate 50 may in direct contact with the solar control layer 62 when the solar control layer 62 is deposited. The substrate 50 is selected such that the solar control layer 62 adheres to the substrate so that the solar control layer 62 may be handled. Because the solar control layer 62 will be in direct contact with the substrate 70 or the intermediate layer 82, the solar control layer 62, the material for the exposed surface of the substrate 70 or the intermediate layer 82 is selected so that the solar control layer 62 adheres more strongly to the exposed surface of the substrate 70 or the intermediate layer 82, as compared to the substrate 50. Other arrangements will have substantially the same issues with respect to relative adhesion.

Embodiments as described herein can be useful for forming members for structures that include a solar control layer. The processing techniques allow a solar control layer to be deposited using a plasma-assisted deposition technique without requiring a substrate or a member of a substrate to be subjected to the plasma. A wide variety of materials can be used with the solar control layer. Further, many of the plasma-assisted techniques allow for good thickness control and can be performed without incorporating particles or other matter that may adversely impact the optical properties of the solar control layer. The solar control layer can be transferred to nearly any substrate that is used along the exterior of a structure. The solar control layer can help to reduce heat within a building, as well as heat absorbed by the substrate, such as with metal bleachers, a playground slide, or the like.

The process described herein is well suited for materials that may degrade during a plasma-assisted deposition, for materials that will have additives that will evaporate in the vacuum during plasma-assisted deposition, where thermal expansion of the materials is too high or too low compared to the thermal expansion of the solar control layer, where the size of a substrate is too large for a deposition chamber, a substrate is relatively fragile or brittle, or unable to withstand the temperature reached during plasma-assisted deposition, or the like. Thus, the process can be adapted to a wide variety of applications.

Many different aspects and embodiments are possible. Some of those aspects and embodiments are described below. After reading this specification, skilled artisans will appreciate that those aspects and embodiments are only illustrative and do not limit the scope of the present invention.

In a first aspect, a member for a structure can include a substrate having a visible outer surface, wherein the substrate is substantially opaque to visible light, and a solar control layer capable of transmitting approximately 5% to approximately 100% of a first radiation having a first wavelength within a visible light spectrum and reflecting approximately 1% to approximately 100% of a second radiation having a second wavelength in a range of 780 nm to 2500 nm. The solar control layer can have a first surface and a second surface opposite the first surface, and the visible outer surface of the substrate can be disposed closer to the first surface than to the second surface. As seen at the second surface of the solar control layer, the solar control layer may not significantly alter the appearance of the member as compared to the member in an absence of the solar control layer.

In an embodiment of the first aspect, the member is part of an exterior surface of a building. In another embodiment, the member forms part of an exterior surface of a building. In still another embodiment, the member is a roofing article, siding, a door, a door frame or a window frame, fencing, decking, or a railing. In a further embodiment, the solar control layer is capable of transmitting at least approximately 50% of the first radiation having the first wavelength. In still a further embodiment, the solar control layer is capable of transmitting at least approximately 70% of the first radiation having the first wavelength. In yet another further embodiment, the solar control layer is capable of reflecting at least approximately 30% of the second radiation having the second wavelength.

In another embodiment of the first aspect, the solar control layer is capable of reflecting at least approximately 60% of the second radiation having the second wavelength. In still another embodiment, the solar control layer includes a metal-containing material. In a particular embodiment, the solar control layer consists essentially of a single film of an electrically conductive oxide. In yet another embodiment, the solar control layer includes a plurality of films. In a particular embodiment, the plurality of films includes an electrically conductive film and a first dielectric film. In a more particular embodiment, the electrically conductive film is disposed between the substrate and the first dielectric film, and the electrically conductive film is protected from an outdoor environment by the first dielectric film. In an even more particular embodiment, the plurality of films further includes a second dielectric film, the second dielectric film is disposed between the substrate and the electrically conductive film, and the electrically conductive film is disposed between the first and second dielectric films. In another embodiment, the substrate includes a polyester, a polyurethane, a polyvinyl butyral, a silicone, a polyimide, a polyamide, a polyolefin, a polyvinyl chloride, a polycarbonate, a polyacrylate, or any combination thereof.

In a further embodiment of the first aspect, the visible outer surface of the substrate is configured to reflect light at a first set of L*, a*, b* coordinates, and the solar control layer is configured to transmit light reflected from the visible outer surface such that, at the second surface, the reflected light has a second set of L*, a*, b* coordinates that are no more than approximately 10 units away from the coordinates of the first set of L*, a*, b* coordinates. In a more particular embodiment, the second L*, a*, b* set of coordinates are no more than approximately 4 units away from the coordinates of the first set of L*, a*, b* coordinates. In still a further embodiment, the member further includes an intermediate layer disposed between the solar control layer and the visible outer surface of the substrate. In a particular embodiment, the intermediate layer includes a polymer other than a fluorine-containing polymer. In a more particular embodiment, the polymer includes a polyester, a polyurethane, a polyvinyl butyral, a silicone, a polyimide, a polyamide, or any combination thereof. In another particular embodiment, the intermediate layer includes a pressure-sensitive adhesive compound. In a more particular embodiment, the pressure-sensitive adhesive compound comprises a silicone, an acrylic polymer, a vinyl-based polymer, or any combination thereof. In yet a further embodiment, the solar control layer is capable of scattering visible light.

In a second aspect, a member for a structure can include a substrate having a visible outer surface, wherein the substrate is substantially opaque to visible light, and a solar control layer capable of transmitting approximately 5% to approximately 100% of a first radiation having a first wavelength within a visible light spectrum and reflecting approximately 1% to approximately 100% of a second radiation having a second wavelength in a range of 780 nm to 2500 nm. The solar control layer can have a first surface and a second surface opposite the first surface, wherein the visible outer surface of the substrate is disposed closer to the first surface than to the second surface, the visible outer surface of the substrate can be configured to reflect light at a first set of L*, a*, b* coordinates, and the solar control layer can be configured to transmit light reflected from the visible outer surface such that, at the second surface, the reflected light has a second set of L*, a*, b* coordinates that are no more than approximately 10 units away from the coordinates of the first set of L*, a*, b* coordinates.

In an embodiment of the second aspect, the member is part of an exterior surface of a building. In another embodiment, the member forms part of an exterior surface of a building. In still another embodiment, the member is a roofing article, siding, a door, a door framing member, fencing, decking, or a railing. In a further embodiment, the solar control layer is capable of transmitting at least approximately 50% of the first radiation having the first wavelength. In a particular embodiment, the solar control layer is capable of transmitting at least approximately 70% of the first radiation having the first wavelength. In another particular embodiment, the solar control layer is capable of reflecting at least approximately 30% of the second radiation having the second wavelength. In still another particular embodiment, the solar control layer is capable of reflecting at least approximately 60% of the second radiation having the second wavelength.

In still a further embodiment of the second aspect, the coordinates of the second set of L*, a*, b* coordinates are no more than approximately 5 units away from coordinates of the first set of L*, a*, b* coordinates. In yet another further embodiment, the solar control layer includes a metal-containing material. In a particular embodiment, the solar control layer consists essentially of a single film of an electrically conductive oxide. In another embodiment, the solar control layer includes a plurality of films. In a particular embodiment, the plurality of films includes an electrically conductive film and a first dielectric film. In a more particular embodiment, the electrically conductive film is disposed between the substrate and the first dielectric film, and the electrically conductive film is protected from an outdoor environment by the first dielectric film. In another more particular embodiment, the plurality of films further includes a second dielectric film, the second dielectric film is disposed between the substrate and the electrically conductive film, and the electrically conductive film is disposed between the first and second dielectric films. In another embodiment, the substrate includes a polyester, a polyurethane, a polyvinyl butyral, a silicone, a polyimide, a polyamide, a polyolefin, a polyvinyl chloride, a polycarbonate, a polyacrylate, or any combination thereof.

In a further embodiment of the second aspect, the member further includes an intermediate layer disposed between the solar control layer and the visible outer surface of the substrate. In a particular embodiment, the intermediate layer includes a polymer other than a fluorine-containing polymer. In a more particular embodiment, the polymer includes a polyester, a polyurethane, a polyvinyl butyral, a silicone, a polyimide, a polyamide, or any combination thereof. In another particular embodiment, the intermediate layer includes a pressure-sensitive adhesive compound. In a more particular embodiment, the pressure-sensitive adhesive compound comprises a silicone, an acrylic polymer, a vinyl-based polymer, or any combination thereof. In still a further embodiment, the solar control layer is capable of scattering visible light.

In a third aspect, a member for a structure can include a substrate having a visible outer surface, wherein the substrate is substantially opaque to visible light, an intermediate layer capable of transmitting approximately 5% to approximately 100% of a first radiation having a first wavelength within a visible light spectrum, and a solar control layer capable of transmitting approximately 5% to approximately 100% of a second radiation having a second wavelength within the visible light spectrum and reflecting approximately 1% to approximately 100% of a third radiation having a third wavelength in a range of 780 nm to 2500 nm. The intermediate layer can be disposed between the substrate and the solar control layer, and the intermediate layer includes a primary material that is susceptible to significant degradation when exposed during a plasma deposition.

In an embodiment of the third aspect, the member is part of an exterior surface of a building. In another embodiment, the member forms part of an exterior surface of a building. In still another embodiment, the member is a roofing article, siding, a door, a door frame or a window frame, fencing, decking, or a railing. In yet another embodiment, the solar control layer is capable of transmitting at least approximately 50% of the second radiation having the second wavelength. In a further embodiment, the solar control layer is capable of transmitting at least approximately 70% of the second radiation having the second wavelength. In another further embodiment, the solar control layer is capable of reflecting at least approximately 30% of the third radiation having the third wavelength. In still a further embodiment, the solar control layer is capable of reflecting at least approximately 60% of the third radiation having the third wavelength.

In another embodiment of the third aspect, the solar control layer has a first surface and a second surface opposite the first surface, and the visible outer surface of the substrate is disposed closer to the first surface than to the second surface. As seen at the second surface of the solar control layer, a combination of the intermediate and solar control layers does not significantly alter the appearance of the member as compared to the member in an absence of the combination of the first and solar control layers. In still another embodiment, the solar control layer has a first surface and a second surface opposite the first surface, the visible outer surface of the substrate is disposed closer to the first surface than to the second surface, and the visible outer surface of the substrate is configured to reflect light at a first L*, a*, b* coordinate. The solar control layer is configured to transmit light reflected from the visible outer surface such that, at the second surface, the reflected light has a second set of L*, a*, b* coordinates that are no more than approximately 10 units away from the coordinates of the first set of L*, a*, b* coordinates. In a particular embodiment, the coordinates of the second set of L*, a*, b* coordinates are no more than approximately 5 units away from the coordinates of the first set of L*, a*, b* coordinates.

In a further embodiment of the third aspect, the intermediate layer includes a polymer other than a fluorine-containing polymer. In a particular embodiment, the polymer includes a polyester, a polyurethane, a polyvinyl butyral, a silicone, a polyimide, a polyamide, or any combination thereof. In still a further embodiment, the intermediate layer has a thickness in a range of approximately 0.1 mm to approximately 2 mm. In a particular embodiment, the intermediate layer includes a pressure-sensitive adhesive compound. In a more particular embodiment, the pressure-sensitive adhesive compound includes a silicone, an acrylic polymer, a vinyl-based polymer, or any combination thereof. In another embodiment, the solar control layer includes a metal-containing material. In still another embodiment, the solar control layer consists essentially of a single film of an electrically conductive oxide.

In a yet another embodiment of the third aspect, the solar control layer includes a plurality of films. In a particular embodiment, the plurality of films includes an electrically conductive film and a first dielectric film. In a more particular embodiment, the electrically conductive film is disposed between the substrate and the first dielectric film, and the electrically conductive film is protected from an outdoor environment by the first dielectric film. In another particular embodiment, the plurality of films further includes a second dielectric film, the second dielectric film is disposed between the substrate and the electrically conductive film, and the electrically conductive film is disposed between the first and second dielectric films. In another embodiment, the substrate comprises a polyester, a polyurethane, a polyvinyl butyral, a silicone, a polyimide, a polyamide, a polyolefin, a polyvinyl chloride, a polycarbonate, a polyacrylate, or any combination thereof. In a further embodiment, the solar control layer is capable of scattering visible light.

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1. A member for a structure comprising:
a substrate having a visible outer surface, wherein the substrate is substantially opaque to visible light; and
a solar control layer capable of transmitting approximately 5% to approximately 100% of a first radiation having a first wavelength within a visible light spectrum and reflecting approximately 1% to approximately 100% of a second radiation having a second wavelength in a range of 780 nm to 2500 nm,
wherein:
the solar control layer has a first surface and a second surface opposite the first surface;
the visible outer surface of the substrate is disposed closer to the first surface than to the second surface; and
as seen at the second surface of the solar control layer, the solar control layer does not significantly alter the appearance of the member as compared to the member in an absence of the solar control layer.

2. The member of claim 1, wherein the member is part of an exterior surface of a building.

3. (canceled)

4. The member of claim 1, wherein the member is a roofing article, siding, a door, a door frame or a window frame, fencing, decking, or a railing.

5. The member of claim 1, wherein the solar control layer is capable of transmitting at least approximately 50% of the first radiation having the first wavelength.

6. (canceled)

7. The member of claim 1, wherein the solar control layer is capable of reflecting at least approximately 30% of the second radiation having the second wavelength.

8-10. (canceled)

11. The member of claim 1, wherein the solar control layer comprises a plurality of films.

12. The member of claim 11, wherein the plurality of films comprises an electrically conductive film and a first dielectric film.

13-14. (canceled)

15. The member of claim 1, wherein the substrate comprises a polyester, a polyurethane, a polyvinyl butyral, a silicone, a polyimide, a polyamide, a polyolefin, a polyvinyl chloride, a polycarbonate, a polyacrylate, or any combination thereof.

16. The member of claim 1, wherein:
the visible outer surface of the substrate is configured to reflect light at a first set of L*, a*, b* coordinates; and
the solar control layer is configured to transmit light reflected from the visible outer surface such that, at the second surface, the reflected light has a second set of L*, a*, b* coordinates that are no more than approximately 10 units away from the coordinates of the first set of L*, a*, b* coordinates.

17. (canceled)

18. The member of claim 1, further comprising an intermediate layer disposed between the solar control layer and the visible outer surface of the substrate.

19-23. (canceled)

24. A member for a structure comprising:
a substrate having a visible outer surface, wherein the substrate is substantially opaque to visible light; and
a solar control layer capable of transmitting approximately 5% to approximately 100% of a first radiation having a first wavelength within a visible light spectrum and reflecting approximately 1% to approximately 100% of a second radiation having a second wavelength in a range of 780 nm to 2500 nm;
wherein:
the solar control layer has a first surface and a second surface opposite the first surface, wherein the visible outer surface of the substrate is disposed closer to the first surface than to the second surface;
the visible outer surface of the substrate is configured to reflect light at a first set of L*, a*, b* coordinates; and
the solar control layer is configured to transmit light reflected from the visible outer surface such that, at the second surface, the reflected light has a second set of L*, a*, b* coordinates that are no more than approximately 10 units away from the coordinates of the first set of L*, a*, b* coordinates.

25-26. (canceled)

27. The member of claim 24, wherein the member is a roofing article, siding, a door, a door frame or a window frame, fencing, decking, or a railing.

28. The member of claim 24, wherein the solar control layer is capable of transmitting at least approximately 50% of the first radiation having the first wavelength.

29-31. (canceled)

32. The member of claim 24, wherein the coordinates of the second set of L*, a*, b* coordinates are no more than approximately 5 units away from coordinates of the first set of L*, a*, b* coordinates.

33-34. (canceled)

35. The member of claim 24, wherein the solar control layer comprises a plurality of films.

36-38. (canceled)

39. The member of claim 24, wherein the substrate comprises a polyester, a polyurethane, a polyvinyl butyral, a silicone, a polyimide, a polyamide, a polyolefin, a polyvinyl chloride, a polycarbonate, a polyacrylate, or any combination thereof.

40-45. (canceled)

46. A member for a structure comprising:
a substrate having a visible outer surface, wherein the substrate is substantially opaque to visible light;
an intermediate layer capable of transmitting approximately 5% to approximately 100% of a first radiation having a first wavelength within a visible light spectrum; and
a solar control layer capable of transmitting approximately 5% to approximately 100% of a second radiation having a second wavelength within the visible light spectrum and reflecting approximately 1% to approximately 100% of a third radiation having a third wavelength in a range of 780 nm to 2500 nm,
wherein:
the intermediate layer is disposed between the substrate and the solar control layer; and
the intermediate layer comprises a primary material that is susceptible to significant degradation when exposed during a plasma deposition.

47-48. (canceled)

49. The member of claim 46, wherein the member is a roofing article, siding, a door, a door frame or a window frame, fencing, decking, or a railing.

50-51. (canceled)

52. The member of claim 46, wherein the solar control layer is capable of reflecting at least approximately 30% of the third radiation having the third wavelength.

53-54. (canceled)

55. The member of claim 46, wherein:
the solar control layer has a first surface and a second surface opposite the first surface;
the visible outer surface of the substrate is disposed closer to the first surface than to the second surface;
the visible outer surface of the substrate is configured to reflect light at a first L*, a*, b* coordinate; and
the solar control layer is configured to transmit light reflected from the visible outer surface such that, at the second surface, the reflected light has a second set of L*, a*, b* coordinates that are no more than approximately 10 units away from the coordinates of the first set of L*, a*, b* coordinates.

56-59. (canceled)

60. The member of claim 46, wherein the intermediate layer has a thickness in a range of approximately 0.1 mm to approximately 2 mm.

61. The member of claim 60, wherein the intermediate layer comprises a pressure-sensitive adhesive compound.

62-69. (canceled)
